(19) United States
(12) Patent Application Publication
(10) Pub. No.: US 2026/0244181 A1
(43) Pub. Date: Aug. 20, 2026

(54) PROGRAMMABLE LOGIC CONTROLLER, INFERENCE EXECUTION SYSTEM, INFERENCE EXECUTION METHOD, AND RECORDING MEDIUM

(71) Applicant: Mitsubishi Electric Corporation, Tokyo (JP)

(72) Inventors: Shingo OIDATE, Tokyo (JP); Weihau LEE, Tokyo (JP); Jijun JIN, Tokyo (JP)

(73) Assignee: Mitsubishi Electric Corporation, Tokyo (JP)

(21) Appl. No.: 18/871,345

(22) PCT Filed: Sep. 29, 2022
(86) PCT No.: PCT/JP2022/036422

§ 371 Date: Dec. 3, 2024

(51) Int. Cl. G05B 19/05; G06N 20/00

(52) U.S. Cl. CPC G05B 19/05; G06N 20/00

(57) ABSTRACT

A programmable logic controller includes a control application to generate execution instruction information indicating an instruction to execute an inference, a plurality of inference applications each to execute the inference and be capable of generating an inference result, and a machine learning platform to identify, in response to the execution instruction information transmitted from the control application, an inference application satisfying a predetermined rule from the plurality of inference applications to cause the identified inference application to execute the inference, and transmit an inference result generated by the identified inference application to the control application.

### TECHNICAL FIELD

The present disclosure relates to a programmable logic controller, an inference execution system, an inference execution method, and a program.

### BACKGROUND ART

Techniques are known for collecting data from factory automation (FA) devices at manufacturing sites and using inference results from artificial intelligence algorithms using the collected data to control the devices. For example, Patent Literature 1 describes an industrial personal computer (PC) device including a control application to output control data for controlling a target device and an inference application to execute an inference using the control data and device data indicating the operation of the device as an input.

### CITATION LIST

### Patent Literature

Patent Literature 1: Unexamined Japanese Patent Application Publication (Translation of PCT Application) No. 2021-531574

### SUMMARY OF INVENTION

### Technical Problem

In the industrial PC device, a single inference application is executed. However, multiple inference applications for various inferences are to be executed for different purposes to control devices at a production site. Thus, the technique may be improved to acquire a suitable inference result from multiple inference applications to suit the purpose of the inference.

In response to the above issue, an objective of the present disclosure is to provide a programmable logic controller, an inference execution system, an inference execution method, and a program for acquiring a suitable inference result from multiple inference applications.

### Solution to Problem

To achieve the above objective, a programmable logic controller according to an aspect of the present disclosure includes a control application to generate execution instruction information indicating an instruction to execute an inference, a plurality of inference applications each to execute the inference and be capable of generating an inference result, and a machine learning platform to identify, in response to the execution instruction information transmitted from the control application, an inference application satisfying a predetermined rule from the plurality of inference applications to cause the identified inference application to execute the inference, and transmit an inference result generated by the identified inference application to the control application.

### Advantageous Effects of Invention

The structure according to the above aspect of the present disclosure includes the machine learning platform that identifies, from the plurality of inference applications, an inference application satisfying the predetermined rule and transmits the inference result generated by the identified inference application to the control application. Thus, a suitable inference result can be acquired from the plurality of inference applications.

### BRIEF DESCRIPTION OF DRAWINGS

FIG. 1 is a block diagram of a programmable logic controller according to Embodiment 1 of the present disclosure illustrating the logic structure;

FIG. 2 is a diagram of an example correspondence table to be referred to by an event broker illustrated in FIG. 1;

FIG. 3 is a block diagram of the programmable logic controller illustrated in FIG. 1 illustrating the physical structure;

FIG. 4 is a flowchart of an inference execution by the programmable logic controller according to the embodiment;

FIG. 5 is a block diagram of a programmable logic controller according to Embodiment 2;

FIG. 6 is a flowchart of an inference execution by the programmable logic controller according to Embodiment 2;

FIG. 7 is a block diagram of an inference execution system according to Embodiment 3;

FIG. 8 is a flowchart of an inference execution by the inference execution system according to Embodiment 3;

FIG. 9 is a block diagram of an inference execution system according to Embodiment 4; and

FIG. 10 is a flowchart of an inference execution by the inference execution system according to Embodiment 4.

### DESCRIPTION OF EMBODIMENTS

A programmable logic controller, an inference execution system, an inference execution method, and a program according to one or more embodiments of the present disclosure are described with reference to the drawings. Like reference signs denote like or corresponding components in the drawings.

### EMBODIMENT 1

A programmable logic controller according to the present embodiment includes a control application to generate control data to control a target device and multiple inference applications to execute different inferences. The control application generates execution instruction information indicating an instruction to execute an inference. The programmable logic controller identifies an inference application that executes an inference matching the purpose of an inference included in the execution instruction information, and instructs the identified inference application to execute the inference. The inference application executes the inference in response to an execution instruction from the programmable logic controller and outputs the inference result to the control application. The control application uses the inference result to control a device.

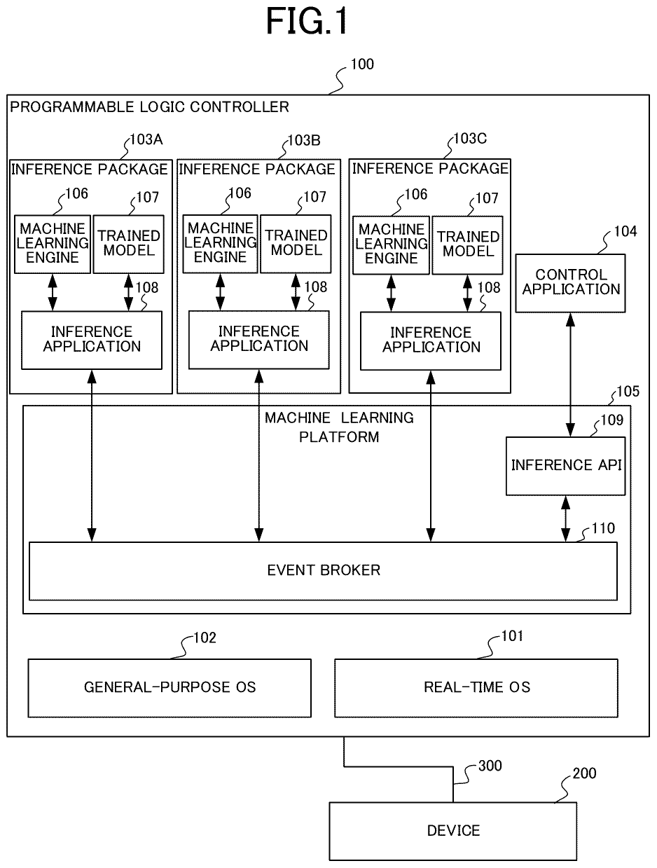

As illustrated in FIG. 1, a programmable logic controller 100 according to the present embodiment is connected to a control target device 200 through a communication channel 300 to communicate with the device 200. The device 200 is, for example, a sensor, an assembly robot, or a drive. The communication channel 300 is an industrial control network implemented by a communication line installed in a factory. The communication channel 300 may be an information network, including a local area network (LAN). The communication channel 300 may be a dedicated line or a wide area network, including the Internet.

The programmable logic controller 100 has the logic structure described below. The programmable logic controller 100 includes a real-time operating system (OS) 101 to execute processing that satisfies time constraints, a general-purpose OS 102 used for various general-purpose applications, inference packages 103A, 103B, and 103C that generate learning models through machine learning based on device data collected from the device 200 and indicating the operation of the device 200 and execute inferences based on the generated learning models, a control application 104 that executes processing for controlling the device 200, and a machine learning platform 105 that exchanges data bidirectionally between the inference packages 103 and the control application 104. The inference packages 103A, 103B, and 103C are hereafter collectively referred to as the inference packages 103.

The real-time OS 101 is designed to execute processing with time constraints. The general-purpose OS 102 is a non-real time OS and does not guarantee real-time responsiveness. The control application 104 is implemented on the real-time OS. The inference packages 103 are implemented on the general-purpose OS 102.

Each inference package 103 includes a machine learning engine 106 that is a runtime for executing machine learning and an inference, a trained model 107 used in the inference, and an inference application 108 that executes the inference. The programmable logic controller 100 includes the multiple inference packages 103A, 103B, and 103C. The multiple inference packages 103A, 103B, and 103C execute inferences for different purposes, such as quality prediction, failure prediction, wear prediction, and control parameter optimization.

The machine learning engine 106 is a runtime for generating and updating a learning model through machine learning and executing an inference based on the trained model 107. Machine learning is executed using any suitable machine learning technique such as neural networks, deep neural networks, reinforcement learning, decision tree learning, genetic algorithms, and classifiers. The input data used for training by the machine learning engine 106 is not limited to the device data but may also be control data generated by the control application 104. These multiple data sets may be used as input data.

The trained model 107 is a learning model used in the inference. The trained model 107 may be a model trained by the machine learning engine 106 or may be pre-trained on the cloud and stored in the programmable logic controller 100.

The inference application 108 calls the trained model 107 and the machine learning engine 106 fitted with the execution environment for the inference application 108, and executes the inference using the trained model 107.

The control application 104 is, for example, written in the Ladder language and controls the operation of the device 200 through an input-output port associated with the device 200. The control application 104 operates on the real-time OS 101. The control application 104 performs collection, processing, diagnosis, and feedback of data from the device 200. Data processing includes smoothing, sharpening, and Fast Fourier transform (FFT) processing. Data diagnosis includes threshold determination and pattern matching. Feedback includes generating control data for controlling the device 200, such as stopping, decelerating, or resuming. The control application 104 communicates with the machine learning platform 105 through an inference application programming interface (API) 109 to provide input data, and provides an instruction to execute an inference. The control application 104 acquires inference results from the inference packages 103 through the inference API 109.

The machine learning platform 105 includes the inference API 109 to exchange data with the control application 104 bidirectionally, and an event broker 110 to identify an inference package 103 matching the purpose of the inference and to exchange data with the inference application 108 included in the identified inference package 103 bidirectionally. The machine learning platform 105 is implemented on the real-time OS 101 and the general-purpose OS 102.

The inference API 109 is an interface for bidirectionally exchanging data with the control application 104. More specifically, the inference API 109 receives, from the control application 104, execution instruction information indicating an instruction to execute an inference and input data used for the inference. The inference API 109 also transmits the inference results output from the inference packages 103 to the control application 104.

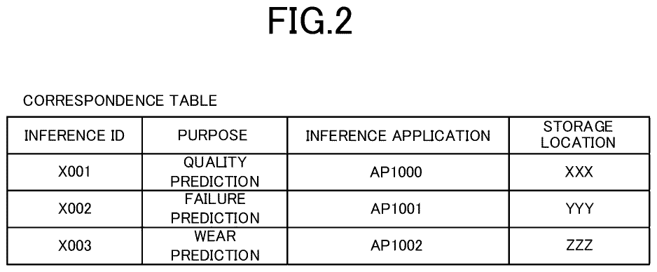

The event broker 110 identifies an inference application 108 matching the purpose of the inference, and exchanges data with the identified inference application 108 bidirectionally. More specifically, the event broker 110 identifies the inference application 108 matching the purpose of the inference based on a correspondence table illustrated in FIG. 2. The correspondence table includes, in a manner associated with one another, the purposes of inferences, the inference applications 108 each for executing a different one of the purpose of the inferences, and locations of storages into which the inference applications 108 are stored. As illustrated in the figure, the correspondence table includes information about inference IDs that are identifiers for identifying the purposes of inferences, uses indicating the purposes of inferences, inference applications as information identifying the inference applications 108, and storage locations indicating addresses of storages into which the inference applications 108 are stored. When the event broker 110 acquires execution instruction information indicating an instruction to execute an inference from the control application 104 through the inference API 109, the event broker 110 identifies an inference application 108 based on the acquired execution instruction information and the correspondence table. For example, when the execution instruction information indicates an instruction to execute an inference for quality prediction, the execution instruction information includes an identifier X001 indicating that the purpose of the inference is quality prediction. The event broker 110 reads the correspondence table, and identifies the inference application 108 with the inference ID of X001 as having identification information of AP1000 and a storage location address of XXX. The event broker 110 then transmits input data to be used for the inference to the identified inference application 108 with AP1000, and instructs the identified inference application 108 to execute the inference. The inference application 108 with AP1000 provides the input data received from the event broker 110 to the trained model 107 to execute the inference for quality prediction. The inference application 108 with AP1000 transmits the inference result acquired through the inference to the event broker 110. The inference result is transmitted to the control application 104 through the inference API 109. The correspondence table is an example of correspondence information.

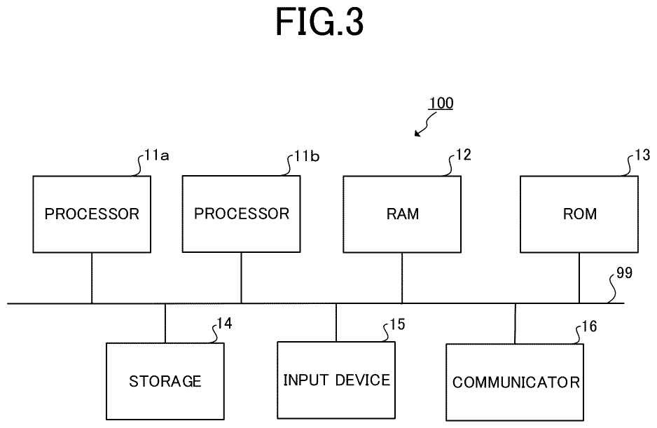

The programmable logic controller 100 has the physical structure described below with reference to FIG. 3. The programmable logic controller 100 includes two processors 11a and 11b to execute processing based on programs, a random-access memory (RAM) 12 as a volatile memory, a read-only memory (ROM) 13 as a nonvolatile memory, a storage 14 to store data, an input device 15 to receive information inputs, and a communicator 16 to transmit and receive information. These components are connected to one another with an internal bus 99.

The processors 11a and 11b each include a central processing unit (CPU).

The processors 11a and 11b read programs stored in the storage 14 into the RAM 12 and execute the programs to execute various processes. The real-time OS 101 illustrated in FIG. 1 operates on the processor 11a. The general-purpose OS 102 operates on the processor 11b.

The RAM 12 is used as a work area for the CPUs. The ROM 13 stores a control program such as Basic Input/Output System (BIOS) executable by the CPUs for the basic operations of the programmable logic controller 100.

The storage 14 includes a hard disk drive. The storage 14 stores programs executable by the CPUs, and stores various sets of data used in program execution. The storage 14 stores the real-time OS 101, the general-purpose OS 102, the inference packages 103, the control application 104, and the machine learning platform 105 illustrated in FIG. 1.

The input device 15 is a user interface including, for example, a keyboard and a mouse. The input device 15 acquires information input by a user, and provides the acquired information to the processors 11a and 11b.

The communicator 16 includes a network terminator or a wireless communication device connected to a network and a serial interface or a LAN interface connected to the network terminator or the wireless communication device. The communicator 16 receives external signals and outputs data indicated by these signals to the processors 11a and 11b. The communicator 16 also transmits signals indicating data output from the processors 11a and 11b to external devices.

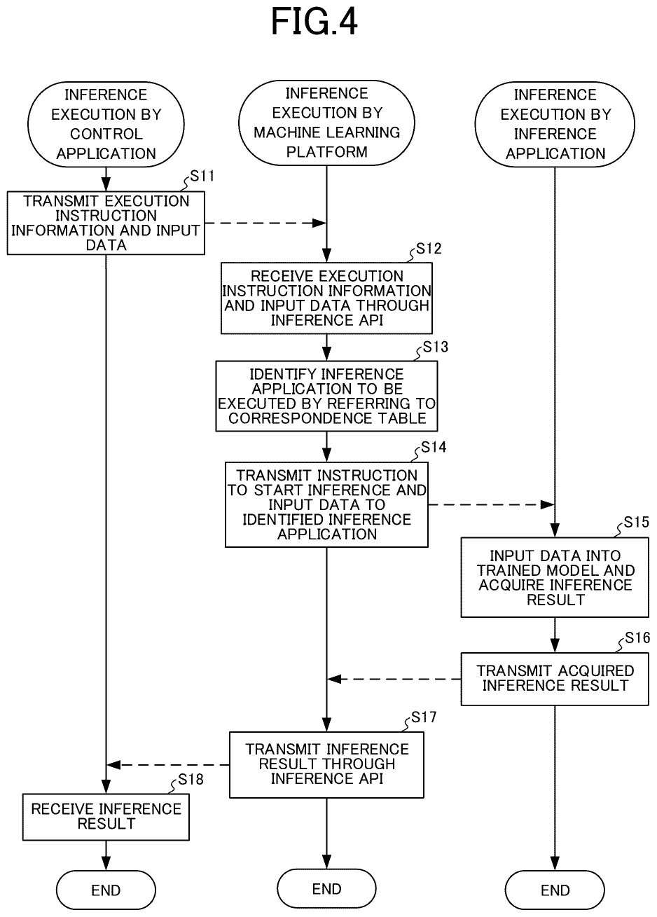

An operation executed by the programmable logic controller 100 with the above structure is described with reference to FIG. 4.

To prepare for inference execution, multiple inference packages 103 are prestored into the storage 14. The user provides training data to the machine learning engines 106 included in the inference packages 103 and causes the machine learning engines 106 to generate, through machine learning, the trained models 107 for executing inferences. The trained models 107 are prestored into the storage 14. More specifically, the training data includes, for example, pairs of input data and output data. The input data includes device data indicating the operation of the device 200 and control data. The output data includes, for example, information indicating the quality of a workpiece, the wear value of the workpiece, and the failure rate of the device 200. The machine learning engines 106 execute machine learning to cause the inference results to approach the result data based on the provided training data and generate the trained model 107 to be stored into the storage 14.

After the inference packages 103 are stored and the trained models 107 are generated, the user generates the correspondence table and causes the storage 14 to prestore the correspondence table. The correspondence table includes, in a manner associated with each other, the purposes of inferences executable by the inference applications 108, the inference applications 108 stored in the storage 14, and information about storages into which the inference applications 108 are stored.

The programmable logic controller 100 that has completed the preparation receives information indicating the purpose of the inference through an engineering tool connected to the programmable logic controller 100, identifies an inference application 108 that matches the purpose of the inference, and performs the inference execution by instructing the identified inference application 108 to execute the inference.

The engineering tool displays an input screen to receive a user input for the purpose of an inference. More specifically, the input screen displays options such as quality prediction, failure prediction, wear prediction, and control parameter optimization. The user operates the input device 15 to select an intended purpose. When the user selects the purpose of an inference and requests the start of the inference execution, the engineering tool notifies the control application 104 of the request. When the control application 104 receives the notification, the programmable logic controller 100 starts the process. The start of the inference execution is not limited to when a user input is received. The user may schedule an inference for each inference purpose, and the inference execution may start automatically at the scheduled date and time.

First, the control application 104 transmits, to the machine learning platform 105, the execution instruction information indicating an instruction to execute an inference for the purpose of the inference selected by the user and input data as an inference target (step S11). The execution instruction information includes an identifier for identifying the purpose of the inference selected by the user. Examples of the input data include device data collected from the device 200, control data output by the control application 104 to the device 200, and various other data sets for inference. The control application 104 may use data collected in real-time as input data or may use data pre-collected and stored in the storage 14 as input data.

The machine learning platform 105 then receives the execution instruction information and the input data transmitted from the control application 104 through the inference API 109 (step S12). The inference API 109 transmits the received execution instruction information and input data to the event broker 110.

The event broker 110 then identifies the inference application 108 to be executed by referring to the correspondence table illustrated in FIG. 2 (step S13). More specifically, the event broker 110 acquires an identifier for identifying the purpose of the inference from the execution instruction information received in step S12. For example, when the execution instruction information indicates an instruction to execute the inference for quality prediction, the execution instruction information includes an identifier X001 indicating that the purpose of the inference is quality prediction. The event broker 110 acquires, from the execution instruction information, the identifier X001 indicating that the purpose of the inference is quality prediction. Subsequently, the event broker 110 refers to the correspondence table and identifies the inference application 108 to be executed and the address of the storage location of the inference application 108 using the extracted identifier X001 as a key. More specifically, the event broker 110 determines whether any data piece matches X001 from the Inference IDs in the correspondence table. The event broker 110 then identifies AP1000 associated with X001 as the inference application 108 to be executed and XXX as the storage address.

Referring back to FIG. 4, the event broker 110 transmits an instruction to start the inference and the input data to the inference application 108 identified in step S13 (step S14). When receiving the start instruction, the inference application 108 reads the prestored trained model 107. The inference application 108 inputs the received input data into the trained model 107 and acquires an inference result output from the trained model 107 (step S15).

The inference application 108 then transmits the inference result acquired in step S15 to the event broker 110 (step S16).

The event broker 110 then transmits the received inference result in step S16 to the control application 104 through the inference API 109 (step S17). When receiving the inference result transmitted in step S17 (step S18), the control application 104 ends the inference execution. The control application 104 then generates control data based on the acquired inference results and controls the device 200.

As described above, the programmable logic controller 100 identifies, from the multiple inference packages 103 for executing inferences for different purposes, an inference package 103 matching an intended inference purpose, and instructs the inference package 103 to execute the inference. This allows execution of a suitable inference application for the purpose of the inference.

### Embodiment 2

In the above embodiment, inference packages 103A to 103C execute inferences for different purposes, and the event broker 110 identifies the inference package 103 matching the purpose of an inference from the inference packages 103A to 103C and instructs the identified inference package 103 to execute the inference. In contrast, a programmable logic controller 100 a according to Embodiment 2 includes multiple inference packages 103 that execute inferences for the same purpose. The programmable logic controller 100a selects, from the inference results output from the inference packages 103, an optimum inference result satisfying a predetermined condition and outputs the selected inference result to a control application 104.

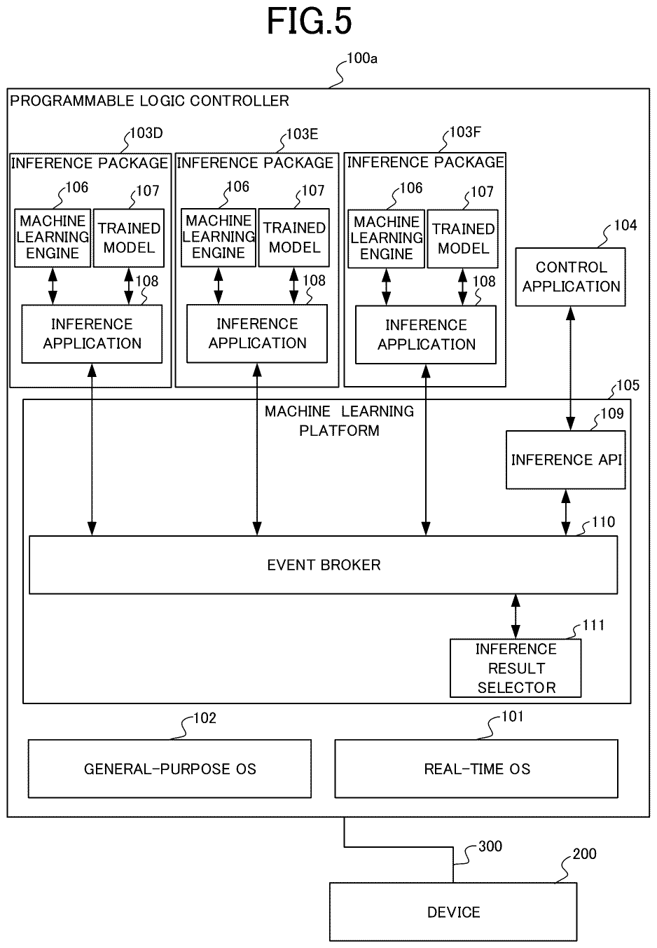

As illustrated in FIG. 5, the programmable logic controller 100a includes the real-time OS 101, the general-purpose OS 102, the control application 104, and the machine learning platform 105 included in the programmable logic controller 100. The programmable logic controller 100a includes inference packages 103D to 103F for the same inference purpose, in place of the inference packages 103A to 103C for different inference purposes. The machine learning platform 105 in the programmable logic controller 100a includes, in addition to the inference API 109 and the event broker 110 included in the programmable logic controller 100, an inference result selector 111 that selects the optimal inference result from the inference results output from the inference packages 103D to 103F.

The inference packages 103D to 103F execute inferences for the same purpose. The inference applications 108 in the inference packages 103D to 103F are executed on different CPUs each including either the real-time OS 101 or the general-purpose OS 102. The inference applications 108 thus have different levels of real-time responsiveness. The inference packages 103D to 103F include different trained models 107. Each inference application 108 executes an inference using the corresponding trained model 107. Thus, the inference applications 108 use different computational amounts to execute the respective inferences. The inference results output from the inference packages 103D to 103F are thus different and take different amounts of time for output.

When providing an instruction to execute an inference, the control application 104 transmits execution instruction information including selection conditions for selecting an inference result to the machine learning platform 105. More specifically, the selection conditions include priority setting for inference results, and include an allowable time for waiting for inference results, and a setting rule for setting priority to the inference results when multiple inference results are received within the allowable time. For the trained models 107 in the inference packages 103D to 103F being neural networks, the setting rule defines higher priority levels for more hierarchical intermediate layers in the neural networks. These selection conditions are preset by the user and stored in the storage 14. The selection conditions are examples of priority setting rules.

The inference result selector 111 selects an inference result to be transmitted to the control application 104 from the inference results output from the inference packages 103D to 103F. More specifically, the inference result selector 111 selects the inference result to be transmitted to the control application 104 under the selection conditions included in the execution instruction information transmitted from the control application 104.

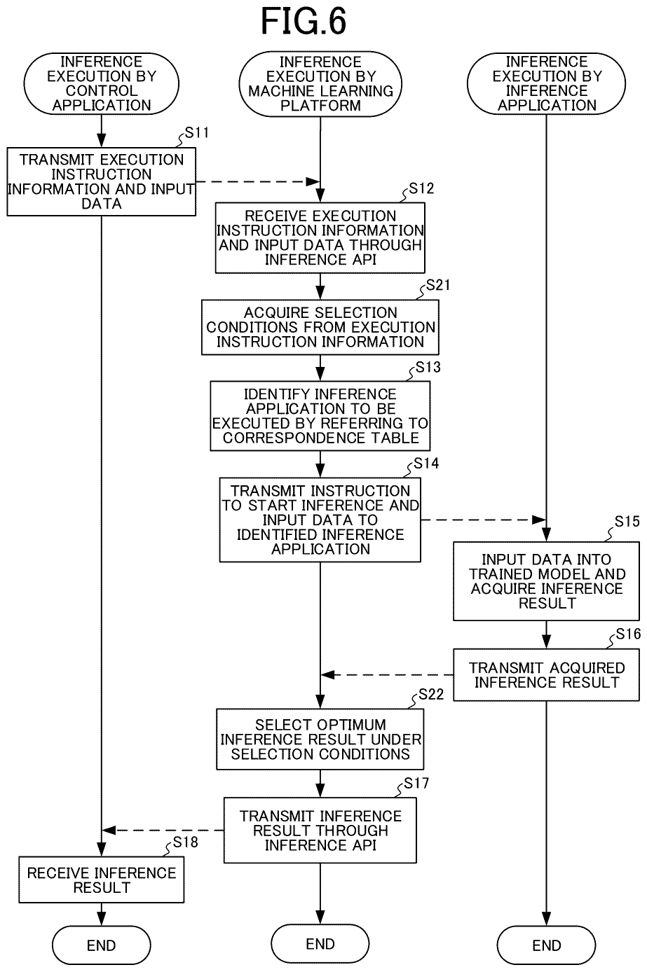

The operation of the programmable logic controller 100a is described with reference to FIG. 6. In the example described below, the inference packages 103D to 103F execute inferences for the same purpose, and the control application 104 indicates an instruction to execute an inference corresponding to the purpose of the inference executable by the inference packages 103D to 103F. In the example described below, the setting conditions prestored into the storage 14 by the user are the allowable time of 0.5 seconds for waiting for inference results and the priority that is set higher for the inference results with more hierarchical layers in the trained model 107. In FIG. 6, the flowchart includes steps common to steps in the flowchart illustrated in FIG. 4. The operation is thus described focusing on the differences.

In step S11, the control application 104 transmits, to the machine learning platform 105, execution instruction information including selection conditions for selecting an inference result, in addition to the purpose of an inference. The control application 104 reads the selection conditions from the storage 14, and transmits the execution instruction information including the read selection conditions.

In step S12, when receiving the execution instruction information through the inference API 109, the event broker 110 in the machine learning platform 105 acquires the selection conditions from the execution instruction information (step S21).

More specifically, the event broker 110 acquires, from the execution instruction information, the selection conditions that are the allowable time of 0.5 seconds for waiting for inference results and the priority that is set higher for the trained models 107 with more hierarchical layers, and outputs the acquired selection conditions to the inference result selector 111.

In step S16, when the inference applications 108 in the inference packages 103D to 103F transmit inference results, the inference result selector 111 selects an optimum inference result from the inference results transmitted from the inference package 103D to 103F under the selection conditions acquired in step S21 (step S22).

More specifically, the inference result selector 111 first extracts any inference result received within the allowable time for waiting for inference results that is set in the selection conditions. The inference result selector 111 calculates a difference between the time at which the start instruction in S14 is transmitted and the time at which each inference result from the corresponding inference package 103D, 103E, or 103F is received, and determines whether the calculated difference is less than or equal to the allowable time of 0.5 seconds. When multiple inference results received within 0.5 seconds are available, the inference result selector 111 acquires the number of hierarchical layers in each trained model 107, and sets priority with higher levels for more hierarchical layers. The inference result selector 111 determines the inference result with the highest priority level as the optimal inference result. When a single inference result is received within the allowable time, the inference result selector 111 may determine the inference result received within the allowable time as an optimum inference result without setting priority.

As described above, the programmable logic controller 100a includes the multiple inference packages 103 that execute inferences for the same purpose but have different computational amounts and different levels of real-time responsiveness. The programmable logic controller 100a selects the optimal inference result from the inference results output from the multiple inference packages 103 under predetermined selection conditions. The user can customize selection conditions for the purpose of the inference to acquire an optimum inference result, with execution of the inference applications 108 that use, for example, different machine learning techniques and learning models.

### Embodiment 3

In the above embodiment, the programmable logic controller 100 has the inference packages 103 that are pre-installed. The present disclosure is not limited to this example. The inference packages 103 may be downloaded from an external server different from the programmable logic controller 100 and extracted into the programmable logic controller 100 for execution of inferences.

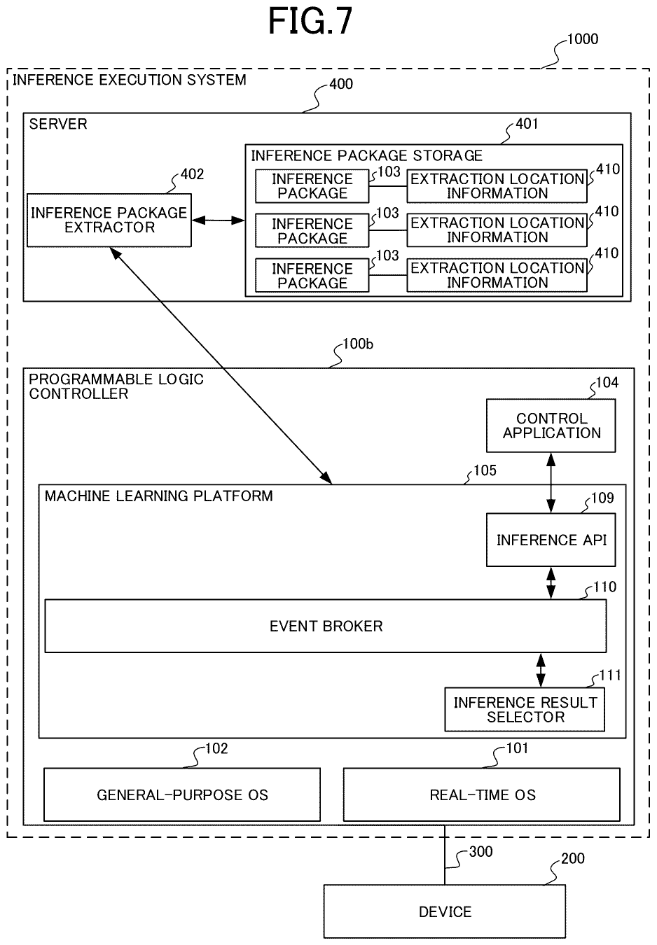

More specifically, an inference execution system 1000 according to Embodiment 3 includes a server 400 and a programmable logic controller 100b, as illustrated in FIG. 7.

The server 400 includes an inference package storage 401 and an inference package extractor 402. The inference package storage 401 stores, in a manner associated with each other, multiple inference packages 103 and extraction location information 410 indicating the storage locations of the inference packages 103 when extracted into the programmable logic controller 100b. The inference package extractor 402 select an inference package 103 to be extracted into the programmable logic controller 100b and instructs the programmable logic controller 100b to extract the selected inference package.

The extraction location information 410 stored in the inference package storage 401 indicates the location of each inference package 103 extracted into the programmable logic controller 100b, and includes, for example, a directory.

The inference package extractor 402 selects, from the inference package storage 401, an inference package 103 matching the purpose of the inference transmitted from the programmable logic controller 100b. More specifically, the inference package storage 401 prestores a correspondence table including, in a manner associated with one another, inference purposes, inference applications, and the storage locations of the inference applications. The inference package extractor 402 refers to the correspondence table to identify the inference package 103 matching an input inference purpose. The inference package extractor 402 transmits the identified inference package 103 together with the extraction location information 410 to the programmable logic controller 100b, and instructs the programmable logic controller 100b to extract the transmitted inference package 103. The inference package extractor 402 is an example of an inference application selector.

The programmable logic controller 100b includes the real-time OS 101, the general-purpose OS 102, the control application 104, and the machine learning platform 105 included in the programmable logic controller 100a. The machine learning platform 105 in the programmable logic controller 100b includes the inference API 109, the event broker 110, and the inference result selector 111 included in the programmable logic controller 100a.

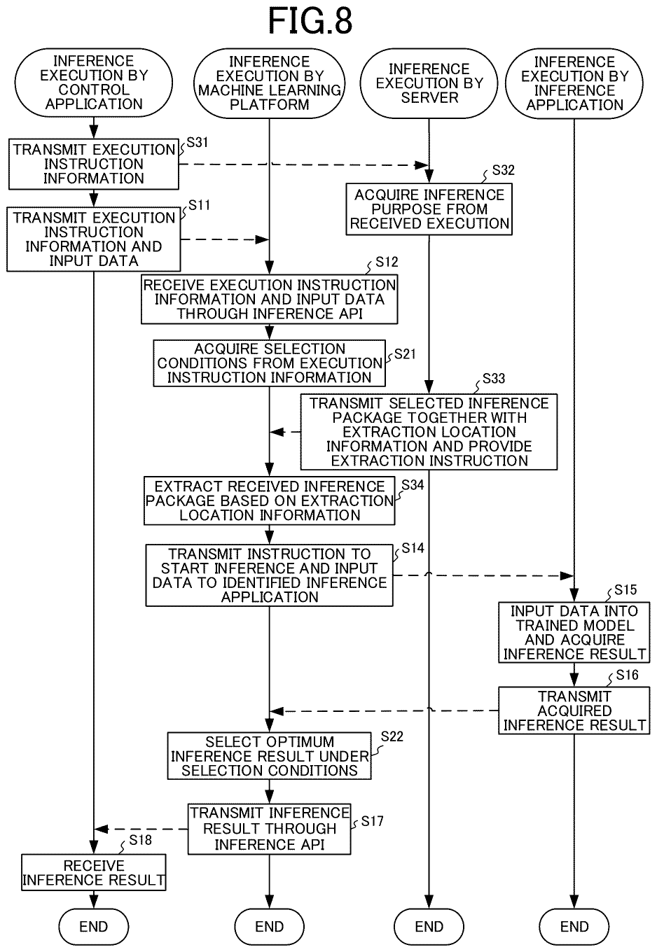

The operation of the inference execution system 1000 is described with reference to FIG. 8. In FIG. 8, the flowchart includes steps common to steps in the flowcharts illustrated in FIGS. 4 and 6. The operation is thus described focusing on the differences.

In step S31, the control application 104 transmits execution instruction information including an identifier for identifying the purpose of the inference to the server 400 (step S31).

The inference package extractor 402 in the server 400 then acquires the purpose of the inference from the execution instruction information transmitted from the programmable logic controller 100b, and selects an inference package 103 matching the acquired inference purpose from the inference package storage 401 (step S32). More specifically, the inference package extractor 402 acquires the identifier to identify the purpose of the inference from the execution instruction information. The inference package extractor 402 then identifies an inference package 103 by referring to the correspondence table.

The inference package extractor 402 then transmits the selected inference package 103 together with the extraction location information to the machine learning platform 105 and instructs the machine learning platform 105 to extract the inference package 103 (step S33). The machine learning platform 105 extracts the received inference package based on the acquired extraction location information (step S34).

The machine learning platform 105 then instructs the inference application 108 in the extracted inference package 103 to start an inference (step S14).

As described above, the programmable logic controller 100b downloads the inference package 103 matching the purpose of the inference from the inference packages 103 stored in the server 400 and executes the inference package 103. The inference packages 103 are thus not to be stored constantly in the programmable logic controller 100b, reducing the likelihood of increasing the memory size of the storage 14.

### Embodiment 4

In Embodiment 3, the inference package 103 matching the input inference purpose is downloaded from the server 400. The present disclosure is not limited to this example. The server 400 may select, in addition to the purpose of the inference, an inference package 103 predicted to yield an optimum inference result, and cause the programmable logic controller 100 to download the inference package 103.

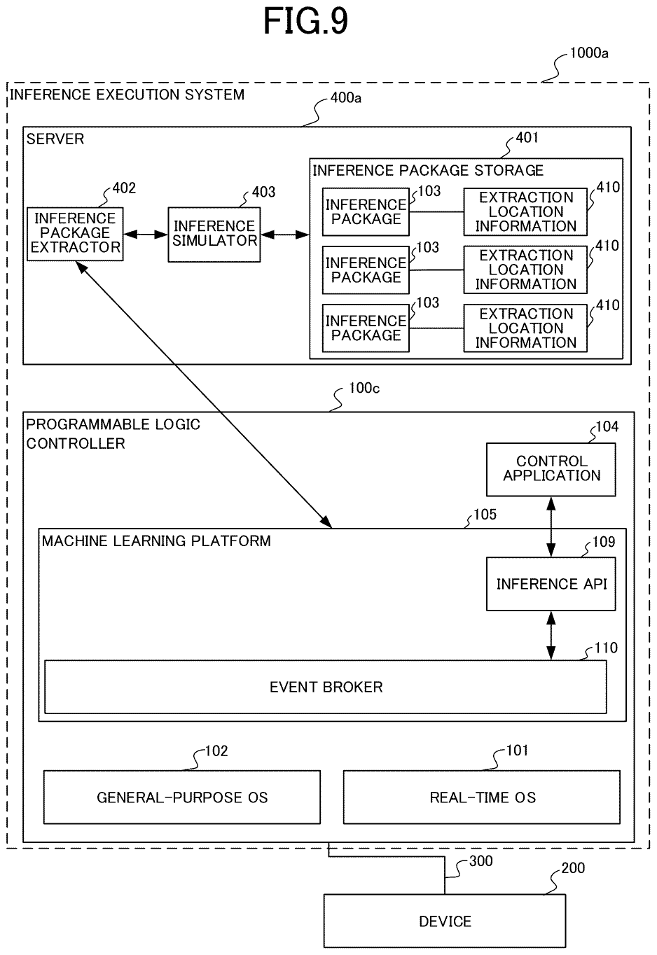

More specifically, an inference execution system 1000a according to Embodiment 4 includes a server 400a and a programmable logic controller 100c, as illustrated in FIG. 9.

The server 400a includes, in addition to the inference package storage 401 and the inference package extractor 402 included in the server 400, an inference simulator 403 that simulates the time taken for the inference executed by each inference package 103.

The inference simulator 403 uses a virtual programmable logic controller to predict the time taken for the inference executed by each inference package 103. The virtual programmable logic controller is a pseudo reproduction of the programmable logic controller 100c that is pre-built on the server 400a. The inference simulator 403 is an example of a predictor.

The programmable logic controller 100c includes the real-time OS 101, the general-purpose OS 102, the control application 104, and the machine learning platform 105 included in the programmable logic controller 100b. The machine learning platform 105 in the programmable logic controller 100c includes the inference API 109 and the event broker 110 included in the programmable logic controller 100b without including the inference result selector 111.

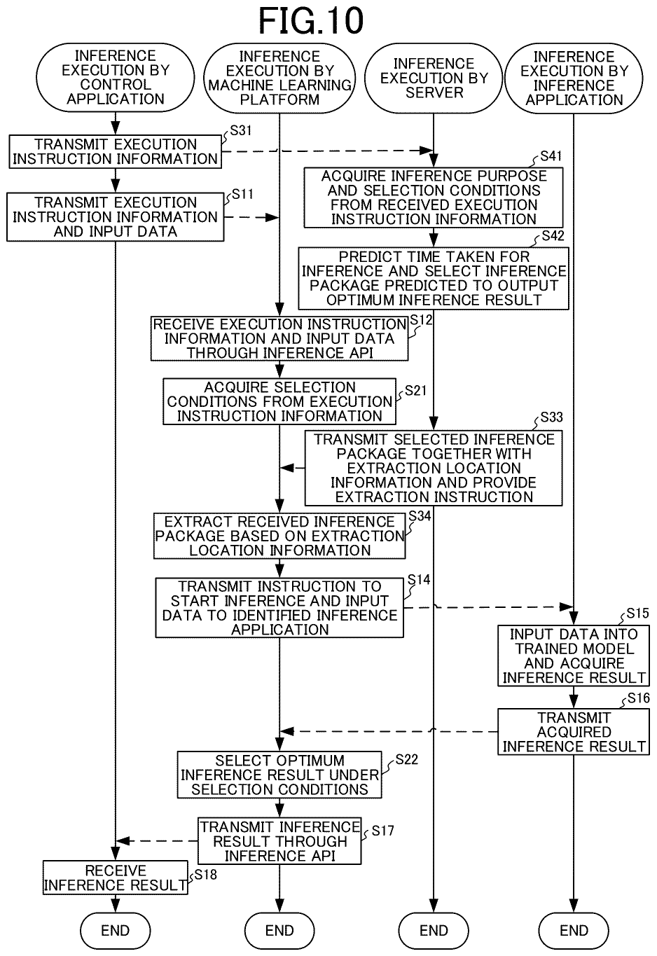

The operation of the inference execution system 1000a is described with reference to FIG. 10. In FIG. 10, the flowchart includes steps common to steps in the flowchart illustrated in FIG. 8. The operation is thus described focusing on the differences.

In step S31, the control application 104 transmits, to the server 400a, execution instruction information including an identifier identifying the purpose of an inference and the selection conditions (step S31). As described in Embodiment 2, the selection conditions include the allowable time that is the time for waiting for inference results to be received after transmission of the execution instruction information, and a setting rule for setting priority for the inference results.

The inference package extractor 402 in the server 400a then acquires the purpose of the inference and the selection conditions from the execution instruction information transmitted from the programmable logic controller 100c (step S41). The inference package extractor 402 refers to a correspondence table to identify multiple inference packages 103 matching the acquired inference purpose.

The inference simulator 403 then predicts the time taken for each of the multiple inference packages 103 specified in step S41 to execute the inference (step S42). More specifically, the inference simulator 403 executes the inference packages 103 on the virtual programmable logic controller pre-built on the server 400a and acquires the prediction times taken for the respective inferences. The inference simulator 403 transmits the acquired prediction times to the inference package extractor 402. The inference package extractor 402 selects an optimum inference package 103 satisfying the selection conditions based on the selection conditions acquired in step S41. More specifically, the inference package extractor 402 selects any inference package 103 with a prediction time within the allowable time included in the selection conditions. When multiple inference packages 103 with the prediction time within the allowable time are determined to be available, the inference package extractor 402 provides a priority level to each inference package 103 under the setting rule for setting priority included in the selection conditions. The inference package extractor 402 selects the inference package 103 with the highest priority level as an optimal inference package 103. The inference package extractor 402 then transmits the selected inference package 103 together with the extraction location information, and provides an extraction instruction.

As described above, in the inference execution system 1000a, the server 400a storing the inference packages 103 selects the optimal inference package 103 that satisfies the purpose of the inference and the selection conditions, and transmits the inference package 103 to the programmable logic controller 100c. Thus, when multiple inference packages matching the purpose of the inference are available, the programmable logic controller 100c is, for example, not to execute the multiple inference packages or not to select, for transmission to the control application 104, an optimum one of the multiple inference results acquired from executing the inference packages 103.

Thus, the programmable logic controller 100c can have higher processing efficiency.

Although one or more embodiments of the present disclosure have been described above, the present disclosure is not limited to the above embodiments.

In the above embodiment, although each inference application 108 executes an inference for one purpose, the inference application 108 may execute inferences for multiple purposes. In this case, multiple inference IDs may be linked with one inference application 108 and registered with the correspondence table illustrated in FIG. 2.

In the above embodiments, three inference packages 103 are used. However, any number of, but at least two, inference packages 103 may be used. In this case, the correspondence table illustrated in FIG. 2 may be defined based on the number of inference applications 108 included in the set inference package 103.

In the above embodiment, the machine learning engines 106 train learning models through machine learning using, as input data, device data collected from the device 200 to be controlled. The present disclosure is not limited to this example. The input data used by the machine learning engines 106 for training may be control data generated by the control application 104, other than the device data alone. These multiple different sets of data may be used as input data.

Different selection conditions may be set for different inference purposes.

In this case, the correspondence table stored in the storage 14 may include, in a manner associated with each other, inference IDs identifying the purposes of inferences and selection conditions for each inference ID. The control application 104 may acquire selection conditions associated with the inference ID for the purpose of the inference selected by the user, and transmit the execution instruction information including the acquired selection conditions to the machine learning platform 105.

In the above example, the rule for setting the priority for the inference results defines higher levels for more hierarchical layers in the trained model 107. The present disclosure is not limited to this example. Any rule other than the above may be set. For example, a trained model 107 with more parameters may have a higher priority level. Inference results yielded with different machine learning techniques may have different priority levels. An inference result output earlier may have a higher priority level.

In Embodiments 2 and 4, one optimum inference result is selected from multiple inference results. The present disclosure is not limited to this example. For example, instead of setting the priority, the inference results may be calculated through computation using, for example, the average, median, or mode values of multiple inference results. In this case, the machine learning platform 105 or the inference result selector 111 may have the computation being predefined. The priority setting may also be performed in combination with the computation to yield an inference result. For example, multiple inference results received within the allowable time may undergo the computation, and the computation result is yielded as an inference result.

In step S16, the inference result selector 111 calculates the difference between the time at which the start instruction in S14 is transmitted and the time at which the inference result from each inference package 103 is received, and determines whether the calculated difference is less than or equal to the allowable time. The present disclosure is not limited to this example. The inference result selector 111 may calculate the difference between the time at which the execution instruction information is received from the control application 104 and the time at which the inference result from each inference package 103 is received and compare the difference with the allowable time.

The functions of the programmable logic controller 100 may be implemented by a common computer system without using a dedicated device. For example, programs for implementing the functions of the programmable logic controller 100 may be stored in a non-transitory computer-readable recording medium, such as a compact disc read-only memory (CD-ROM) or a digital versatile disc read-only memory (DVD-ROM), distributed, and installed in a computer to implement the above functions.

When the functions are implementable by the operating system (OS) and an application in a shared manner or through cooperation between the OS and the application, the application alone may be stored in a non-transitory recording medium.

The components described in the above embodiments may be selected or modified as appropriate without departing from the spirit and scope of the present disclosure.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

100, 100a, 100b, 100c Programmable logic controller
101 Real-time OS
102 General-purpose OS
103, 103A, 103B, 103C, 103D, 103E, 103F Inference package
104 Control application
105 Machine learning platform
106 Machine learning engine
107 Trained model
108 Inference application
109 Inference API
110 Event broker
111 Inference result selector
200 Device
300 Communication channel
400, 400a Server
401 Inference package storage
402 Inference package extractor
403 Inference simulator
410 Extraction location information
11a, 11b Processor
12 RAM
13 ROM
14 Storage
15 Input device
16 Communicator
99 Internal bus
1000, 1000a Inference execution system

1. A programmable logic controller, comprising:
a control application to generate execution instruction information indicating an instruction to execute an inference;
a plurality of inference applications each to execute the inference and be capable of generating an inference result; and
a machine learning platform to identify, in response to the execution instruction information transmitted from the control application, an inference application satisfying a predetermined rule from the plurality of inference applications to cause the identified inference application to execute the inference, and transmit an inference result generated by the identified inference application to the control application, wherein
the execution instruction information includes a priority setting rule to set priority levels for the plurality of inference results generated by the plurality of inference applications, and
the machine learning platform acquires the priority setting rule from the execution instruction information, sets, based on the acquired priority setting rule, a priority level for each of the plurality of inference results generated by the plurality of inference applications, and transmits an inference result with a highest set priority level to the control application.

2. The programmable logic controller according to claim 1, wherein
the machine learning platform receives the identified inference application from an external device storing the plurality of inference applications, and transmits an inference result generated by the received inference application to the control application.

3. The programmable logic controller according to claim 1, wherein
the execution instruction information includes information indicating a purpose of the inference, and
the machine learning platform refers to correspondence information to identify an inference application matching the purpose of the inference included in the execution instruction information transmitted from the control application, instructs the identified inference application to execute the inference, and transmits an inference result generated by the inference application instructed to execute the inference to the control application, and the correspondence information includes, in a manner associated with each other, the plurality of inference applications and purposes of inferences executable by the plurality of inference applications.

4. The programmable logic controller according to claim 1, wherein
the machine learning platform instructs each of the plurality of inference applications to execute the inference and transmits an inference result generated based on a plurality of inference results generated by the plurality of inference applications to the control application.

5. (canceled)

6. The programmable logic controller according to claim 1, wherein
the priority setting rule includes an allowable time to wait for the plurality of inference results to be transmitted from the plurality of inference applications, and
the machine learning platform extracts, based on the priority setting rule, an inference result transmitted within the allowable time from the plurality of inference results transmitted from the plurality of inference applications, sets a priority level for the extracted inference result, and selects an inference result with a highest set priority level as the inference result to be transmitted to the control application.

7. An inference execution system, comprising:
a programmable logic controller to control a target device; and
a server storing a plurality of inference applications,
wherein the programmable logic controller includes
a control application to generate execution instruction information indicating an instruction to execute an inference, and
a machine learning platform to transmit the execution instruction information generated by the control application, and instruct an inference application transmitted from the server in response to the execution instruction information to execute the inference,
the server includes inference application selector selecting circuitry to identify, from the stored plurality of inference applications, an inference application satisfying a predetermined rule, and transmit the identified inference application to the machine learning platform,
the execution instruction information includes a priority setting rule to set priority levels for the plurality of inference results generated by the plurality of inference applications, and
the machine learning platform acquires the priority setting rule from the execution instruction information, sets, based on the acquired priority setting rule, a priority level for each of the plurality of inference results generated by the plurality of inference applications. and transmits an inference result with a highest set priority level to the control application.

8. The inference execution system according to claim 7, wherein
the inference application selector selecting circuitry refers to correspondence information to identify an inference application matching a purpose of the inference included in the execution instruction information generated by the control application and transmits the identified inference application to the machine learning platform, and the correspondence information includes, in a manner associated with each other, the plurality of inference applications stored in the server and purposes of inferences executable by the plurality of inference applications.

9. The inference execution system according to claim 7, wherein
the priority setting rule includes an allowable time to wait for the plurality of inference results to be transmitted from the plurality of inference applications,
the server further includes predicting circuitry to predict a time taken for each of the plurality of inference applications to output an inference result, and
the inference application selector selecting circuitry extracts, based on the priority setting rule, an inference application having a time predicted by the predictor predicting circuitry within the allowable time from the stored plurality of inference applications, sets a priority level to the extracted inference result application, and transmits an inference application with a highest set priority level to the machine learning platform.

10. An inference execution method, comprising:
acquiring execution instruction information from a control application;
acquiring, from the acquired execution instruction information, a priority setting rule to set priority levels for a plurality of inference results generated by a plurality of inference applications; and
identifying, in response to the acquired execution instruction information, an inference application satisfying a predetermined rule from the plurality of inference applications to execute the identified inference application, setting, based on the acquired priority setting rule, a priority level for each of the plurality of inference results generated by the plurality of inference applications, and transmitting an inference result with a highest set priority level to the control application.

11. A non-transitory computer-readable recording medium storing a program, the program causing a computer to perform operations comprising:
acquiring execution instruction information from a control application;
acquiring, from the acquired execution instruction information, a priority setting rule to set priority levels for a plurality of inference results generated by a plurality of inference applications; and
identifying, in response to the acquired execution instruction information, an inference application satisfying a predetermined rule from the plurality of inference applications to execute the identified inference application, setting, based on the acquired priority setting rule, a priority level for each of the plurality of inference results generated by the plurality of inference applications, and transmitting an inference result with a highest set priority level to the control application.

12. The programmable logic controller according to claim 3, further comprising:
a storage to store selection conditions correspondence information including, in a manner associated with each other, the purposes of inferences and priority setting rules, wherein
the control application identifies, based on the selection conditions correspondence information stored in the memory, the priority setting rule corresponding to the purpose of the inference, and generates the execution instruction information including the purpose of the inference and the identified priority setting rule.
